(19) United States
(12) Patent Application Publication
(10) Pub. No.: US 2009/0242474 A1
(43) Pub. Date: Oct. 1, 2009

(54) Hollow fiber membrane module

(75) Inventors: Hiroyasu Shirakawa, Shizuoka (JP); Kensuke Watanabe, Shizuoka (JP)

Correspondence Address: Davidson, Davidson & Kappel, LLC, 485 7th Avenue, 14th Floor, New York, NY, 10018, US

(73) Assignee: NOK Corporation, Tokyo (JP)

(21) Appl. No.: 12/080,177

(22) Filed: Apr. 1, 2008

(51) Int. Cl. B01D 63/04

(52) U.S. Cl. 210/321.84

(57) ABSTRACT

Case 10 is characterized by providing a pair of mutually facing surfaces, and a pair of side surfaces which join that pair of surfaces, opening 11 which is the entrance is formed on one of the surfaces 10a of the opposing pair of surfaces, while the opening 12 which is the exit is formed on the other surface 10b, and spaces S1 and S2 are provided between one surface 10a and the hollow fiber membrane stack 20, and between the other surface 10b and the hollow fiber membrane stack 20 in the entire domain in the direction from one side extreme of case 10 to the other side extreme, with the exception of the part where sealing and fixing devices 31 and 32 are provided, moreover, no space is configured between the pair of side surfaces and the hollow fiber membrane stack 20.

### DETAILED DESCRIPTION OF THE INVENTION

### Technical Field

The present invention relates to hollow fiber membrane modules.

### BACKGROUND

The hollow fiber membrane module is used in every field where the membrane separation effect can be used (water purifiers and such like). In particular, in recent years, their use as humidification devices in maintaining humidity in the ion exchange membranes of fuel cells is receiving a lot of attention.

Here, in the hollow fiber membrane module, in respect of the total membrane surface area of the hollow fiber membrane storable within the case, increasing the usable proportion of membrane surface area is one major issue. This is influenced in a big way, in the case of humidifying hollow fiber membrane modules, by the humidifying efficiency. In the case of cross-flow separation using hollow fiber membrane modules for humidification, the manner of flow of the fluid flowing along the outer wall surface side of the hollow fiber membrane has a big influence on the above subject, and enabling uniform flow of fluid in the case by any means is a particularly big issue.

In order to make the flow of the said fluid within the case uniform, it is better to use a cube shaped case than a cylinder shaped case. This point is explained while referring to FIGS. 11 and 12. FIG. 11 is a drawing explaining the fluid flow when seen from the front side of a conventional hollow fiber membrane module. Now, in FIG. 11 the flow of the fluid is shown by a partial cross-section (the upper half is a frontal view, while the lower half is a cross-section) as seen from the front side. FIG. 12 is a diagram explaining the flow of fluid in a conventional hollow fiber membrane module as seen from the front surface side.

The hollow fiber membrane module 300 provides a hollow fiber membrane stack 320 by stacking plural hollow fiber membranes, and a case 310 which contains the hollow fiber membrane stack 320. The case 310 is configured of substantially cube shaped materials having substantially rectangular cross-sectioned cylindrical parts. Moreover, of two opposing pair of sides of the body part of case 310 on one side the opening means 311 for entrance of fluid is formed, and on the other side opening means 312 is formed as the fluid exit. Moreover, opening means 311 which is the entrance is formed on one end of case 310, and the opening means 312 which is the exit is formed on the other end of case 310.

In the case of a hollow fiber membrane module 300 configured in this way, the fluid which enters from opening means 311 flows transversely across the hollow membrane fiber stack 320, and exits from opening means 312 (Refer to the arrows Z in the diagram). In the situation that the hollow fiber membrane module case is cylinder shaped, it is easy for a variation to arise between the flow volume in the vicinity of the center of the hollow fiber membrane module compared with the peripheral area, whereas in the substantially cube case 310 of the shaped hollow fiber membrane module 300, the difference between the flow volume in the vicinity of the center of hollow fiber membrane stack and the flow volume of the vicinity of the periphery can be controlled. Therefore, the proportion of used membrane surface area can be increased, in respect of the overall hollow fiber membrane surface area, when a cube shaped case shape is used compared with a cylindrical shape.

However, even in a hollow fiber membrane module 300 as described above, it is easy for the flow of fluid to be concentrated in the vicinity of the opening means 311 which is the entrance, and the opening means 312 which is the exit. For this reason, at locations away from these opening means 311 and 312 there are domains where the fluid flow is insufficient. The used proportion of the membrane surface area can be increased by increasing the fluid flow proportion in the perpendicular direction in respect of the long direction of the hollow fiber membrane. But, in the hollow fiber membrane modules 300 as described above, a sufficient reduction in the fluid flow volume in the parallel direction to the long direction of the hollow fiber membrane has not been achieved until now.

Moreover, in the hollow fiber membrane modules 300 as described above, because hollow fiber membranes stacks were simply filled in to case 310, the flow of fluid along the gaps between the hollow fiber membrane stack 320 and the inner wall of the case 310 could not be sufficiently controlled (Refer to arrows Z1 in FIG. 12).

In addition, in the vicinity of the opening means which is the entrance, because the flow of fluid can easily be concentrated, the impact on the hollow fiber membrane is great and there is also the problem that the hollow fiber membranes are easily damaged.

For example, when used as a humidifying device for a fuel cell, in vehicular use some 4000 NL/minute order and in stationary use and some 10-1000 NL/minute of fluid flow through the hollow fiber membrane module. Here, a pipe with a wider internal diameter of 12 to 60 mm is used to flush fluid to the hollow fiber membrane module in order to reduce pressure losses.

Because of this, a great volume of fluid flows into the hollow fiber membrane module case and in the vicinity of the supply means of fluid to the hollow fiber membrane module a localized high fluid pressure effect is generated. As a result, the flow of fluid in the case can become non-uniform and the hollow fiber membrane can be damaged.

Now, there is related technology disclosed in Patent References 1 to 3.

Patent Reference 1: Japanese Unexamined Patent Application Publication No. 2005-224719

Patent Reference 2: Japanese Unexamined Patent Application Publication No. 2004-6100

Patent Reference 3: Japanese Unexamined Patent Application Publication No. 2005-34715

### SUMMARY OF THE INVENTION

One objective of the present invention is the provision of a hollow fiber membrane module which aims to increase the used proportion of the hollow fiber membrane surface area.

The hollow fiber membrane module of the present invention is characterized by providing plural hollow fiber membranes stacked in hollow fiber membrane stacks, and a cylindrical case storing the said hollow fiber membrane stacks, and a sealing fixing means to seal and fix the terminals of each said hollow fiber membrane stack at one end and at the other end of said case enabling the release of the hollow part of each of the hollow fiber membranes, and on the body of said case, forming an opening means on one extreme side of the case as the entrance for the fluid route along the outer surface side of the hollow fiber membranes in the case, moreover, the opening to become the exit is formed on the other extreme side of the case of the hollow fiber membrane module, said case provides a pair of surfaces facing each other, and another pair of surfaces joining that pair of surfaces, and in addition to the opening means which becomes the said entrance being formed on one surface of the said opposing pair of surfaces, and the opening means which becomes the said exit being formed on the other surface, a gap is formed between one of said opposing pair of surfaces and the hollow fiber membrane stack, and between the other opposing surface and the hollow fiber membrane stack in the domain in the direction from one extreme side of the case to the other extreme side of the case with the exception of the part providing the said sealed fixing means, moreover, no gap is configured between said pair of opposing surfaces and the hollow fiber membrane stack.

In the present invention, because the fluid entering from one surface side of the opposing surfaces flows to the other surface side, the variation between the fluid flow in the vicinity of the center of the hollow fiber membrane stack and the fluid flow in the vicinity of the outer side of the stack can be controlled. Then, by means of the gap provided between one surface of the two opposing surfaces and the hollow fiber membrane stack, the fluid which enters from the opening means which is the entrance can flow without meeting much resistance from substantially one extreme side of the case to the other extreme side. Moreover, by means of the gap provided between the other surface of the two opposing surfaces and the hollow fiber membrane stack, the fluid heading to the opening means which is the exit can also flow without meeting much resistance from substantially one extreme side of the case to the other extreme side. By this means, the concentration of the flow of fluid in the vicinity of the opening means which is the entrance and the opening means which is the exit can be mitigated. Because of this, in the whole domain between one extreme side of the case and the other extreme side the proportion of the flow of fluid in the direction perpendicular to the long direction of the hollow fiber membranes can be enlarged. In this way the proportion of used surface area of the membranes in respect of the membrane surface area of the whole hollow fiber membranes stored in the case can be increased. Moreover, because no gap is configured between one pair of sides and the hollow fiber membrane stack, the exit of fluid by the side surface side of the hollow fiber membrane stack, without passing through the hollow fiber membrane stack to the opening means which is the exit, can be controlled.

A gap should not be configured between one of the said opposing pair of surfaces and the hollow fiber membrane stack, or between the other opposing surface and the hollow fiber membrane stack in the two side extremes of the hollow fiber membrane stack.

By this means, the exit of fluid by the side surface side of the hollow fiber membrane stack without passing through the hollow fiber membrane stack to the opening means which is the exit can be effectively controlled.

The gaps formed between one of the said opposing pair of surfaces and the hollow fiber membrane stack, and between the other opposing surface and the hollow fiber membrane stack should be maintained greater than a certain prescribed width as well as providing current plates in each gap to regulate the fluid flow from one extreme side of the case in the direction of the other extreme side.

By this means, the fluid entering from the opening means which is the entrance as well as the fluid heading to the opening means which is the exit can be caused to flow without much resistance over substantially the whole width from one extreme side to the other extreme side of the case.

The said opening means which is the entrance and the said opening means which is the exit should be formed in the width direction domain on substantially the extreme of the full width of the part where the gap is provided.

By this means, the variation between the flow volume in the vicinity of the of the width direction of the hollow fiber membrane stack and the flow in the vicinity of the two side extremes can be controlled.

Plural holes should preferably be formed through the case from inside to outside at locations between the case exterior and the hollow fiber membrane stack along the flow route of the fluid flowing from the opening means which is the said entrance, moreover, shock absorbing materials should preferably be provided to buffer the impact of the flow.

By this means, the impact of the fluid flow entering into the case from the opening means which is the entrance is buffered by the shock absorbing materials. Moreover, by providing multiple holes in the shock absorbing materials, the fluid flow is distributed and lead to the interior of the hollow fiber membrane stack. Therefore, the impact is buffered sequentially and the part of the hollow fiber membrane stack in the vicinity of the entrance can also be utilized effectively.

Said shock absorbing materials are mesh shaped materials, and the hole diameter in the said mesh shaped materials should be from 0.2 mm to less than or equal to 6.0 mm.

Moreover, the mesh shaped materials which are the shock absorbing materials preferably have a void ratio of 40% to less than or equal to 98%.

Now, the above described configurations should be combined as much as possible.

### EFFECT OF THE INVENTION

As described above, by means of the present invention, increases in the proportion of utilized membrane surface area are enabled.

### PREFERRED METHOD OF EMBODYING THE INVENTION

In order to exemplify a preferred embodiment of the present invention, an example is explained in detail below while referring to the drawings. However, the dimensions, materials, shape and respective positions of the configured parts as described in this embodiment, unless specifically so limited, are not meant to limit the scope of this invention to only those specified.

### BRIEF DESCRIPTION OF THE DRAWINGS

FIG. 1 is a cross-section of the use state of the hollow fiber membrane module of embodiment 1 of the present invention.

FIG. 2 is a partial cross-section of the hollow fiber membrane module of embodiment 1 of the present invention as seen from the front. FIG. 3 is a cross-section of the hollow fiber membrane module of embodiment 1 of the present invention sectioning parallel to the hollow fiber membrane.

FIG. 4 is a cross-section diagram of the hollow fiber membrane module of embodiment 1 of the present invention sectioning perpendicular to the hollow fiber membrane.

FIG. 5 is an explanatory diagram of the flow mode of the fluid along the exterior wall of the hollow fiber membrane in the hollow fiber membrane module of embodiment 1 of the present invention.

FIG. 6 is an explanatory diagram of the flow mode of the fluid along the exterior wall of the hollow fiber membrane in the hollow fiber membrane module of embodiment 1 of the present invention.

FIG. 7 is an explanatory diagram of the flow mode of the fluid along the exterior wall of the hollow fiber membrane in the hollow fiber membrane module of embodiment 1 of the present invention.

FIG. 8 is a cross-section of the use state of the hollow fiber membrane module of embodiment 2 of the present invention.

FIG. 9 is a partial cross-section of the hollow fiber membrane module of embodiment 2 of the present invention as seen from the front

FIG. 10 is a cross-section of the hollow fiber membrane module of embodiment 2 of the present invention sectioning parallel to the hollow fiber membrane.

FIG. 11 is an explanatory diagram of the fluid flow in the conventional hollow fiber membrane module as seen from the front side.

FIG. 12 is an explanatory diagram of the fluid flow in the conventional hollow fiber membrane module as seen from the side.

### EMBODIMENT 1

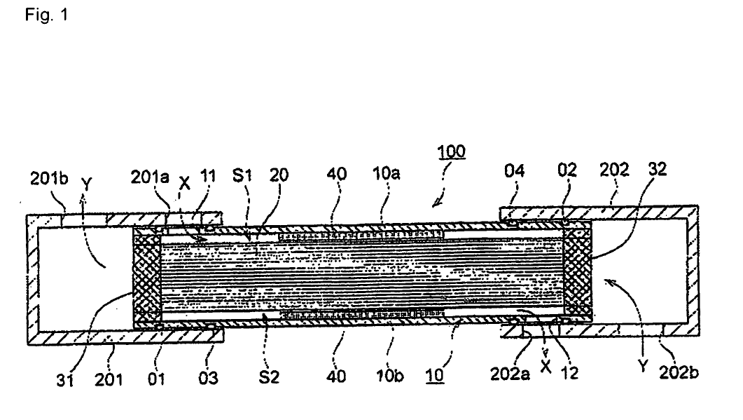

The hollow fiber membrane module of the first embodiment of the present invention is explained below while referring to FIG. 1 to FIG. 7.

### Configuration of the Hollow Fiber Membrane Module

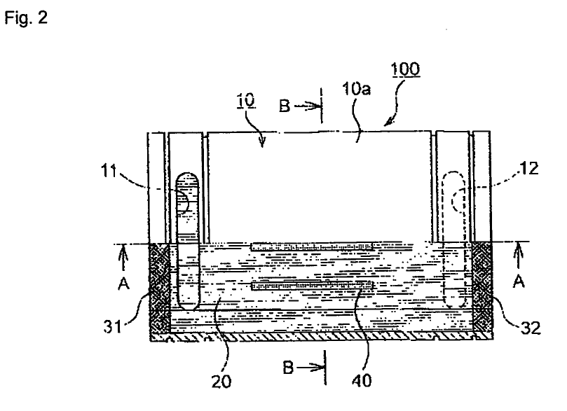

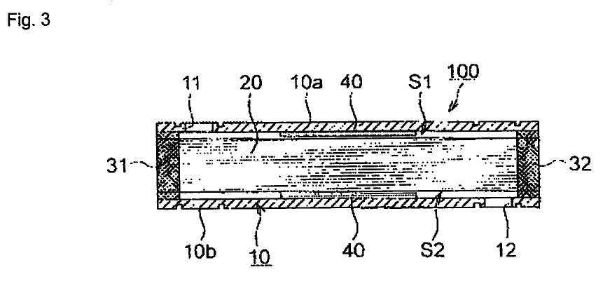

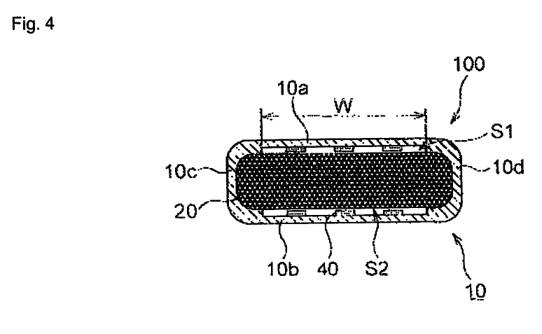

The configuration of the hollow fiber membrane module of the first embodiment of the present invention is explained below while referring to FIG. 1 to FIG. 4. FIG. 1 is a cross-section of the use state of the hollow fiber membrane module of embodiment 1 of the present invention. FIG. 2 is a partial cross-section of the hollow fiber membrane module of embodiment 1 of the present invention as seen from the front. (The upper half is an elevated view of the front and the lower half is a cross-section). FIG. 3 is a cross-section of the hollow fiber membrane module of embodiment 1 of the present invention sectioning parallel to the hollow fiber membrane. Now, FIG. 3 is a cross-section of FIG. 2 at AA. FIG. 4 is a cross-section diagram of the hollow fiber membrane module of embodiment 1 of the present invention sectioning perpendicular to the hollow fiber membrane. Now, FIG. 4 corresponds to a section of FIG. 2 sectioning at BB.

The hollow fiber membrane module 100 of this embodiment of the present invention provides plural hollow fiber membranes stacked in a hollow fiber membrane stack 20 and the case 10 storing hollow fiber membrane stack 20. Then the two extremes of the hollow fiber membrane stack 20 are sealed and fixed to both terminal sides of case 10, releasing the hollow internal part of each hollow fiber membrane. In the diagrams 31 and 32 are the sealed and fixed (potting part) means.

Case 10 is configured with substantially rectangular shaped materials having a cross-section of substantially square shaped cylindrical means. This case 10 provides a mutually facing pair of surfaces (one is 10a and the other is 10b), and a pair of surfaces 10c and 10d joining that pair of surfaces. Then, on one surface 10a opening means 11, which is the fluid entrance to case 10, is formed, while on the other surface 10b, opening means 12 which is the fluid exit, is formed. Moreover, the opening means 11 which is the entrance is formed on one extreme side of case 10, while the opening means 12 which is the exit is formed on the other extreme side.

Then, gap S1 is provided between one surface 10a and the hollow fiber membrane stack 20. Moreover, gap S2 is provided between the other surface 10b and the hollow fiber membrane stack 20. These gaps S1 and S2 are provided extending in respect of the domain direction from one extreme side of case 10 to the other extreme side, excepting the domain part where sealing fixture means 31 and 32 are provided (Refer to FIG. 1 and FIG. 3).

In contrast to this, no gap is provided between the pair of side surfaces 10c and 10d and the hollow fiber membrane stack 20. Moreover, between one surface 10a and the hollow fiber membrane stack 20, and also between the other surface 10b and the hollow fiber membrane stack 20, the extreme ends of both terminals of hollow fiber membrane stack 20 are provided without a gap (Refer to FIG. 4).

Moreover, in the gaps S1 and S2 provided between one surface 10a and the hollow fiber membrane stack 20, and between the other surface 10b and the hollow fiber membrane stack 20, current plates 40 are provided maintaining the spaces of gaps S1 and S2 above a prescribed level and assisting the flow of fluid heading from one extreme side of case 10 to the other extreme side. In this embodiment, three sheets of current plate 40 are provided in each of gaps S1 and S2.

Moreover, in the present embodiment, the width direction domain W of the opening means 11 and 12 are provided formed at substantially the full space extremes of gaps S1 and S2 (Refer to FIG. 4).

The hollow fiber membrane module 100 configured as described above has heads 201 and 202 in a mounted state at both side extremes. Two openings are provided on each of heads 201 and 202, namely 201a, 201b, 202a and 202b.

Then, the fluid which enters case 10 through opening means 11 of case 10 from the opening 201a of head 201 flows along the outer wall surface of the hollow fiber membrane, through opening means 12 of case 10 and exits from opening means 202a of head 202 (Refer to arrow X in FIG. 1). Moreover, the fluid which enters from opening means 202b of head 202 from the other extreme side of case 10, passes through the hollow internal parts of each hollow fiber membrane of hollow fiber membrane stack 20 and passes out from one extreme side of case 10, exiting through opening means 201b of head 201 (Refer to arrow Y in FIG. 1).

In this way, fluid routes are formed through the hollow internal part of the hollow fiber membranes, and along the outside surface wall of the hollow fiber membrane, membrane separation is performed by the cross flow using the hollow fiber membrane. When hollow fiber membrane module 100 is used for humidifying purposes, hydrophilic materials are used as the hollow fiber membranes. By using these, and a gas body subject to humidification is flushed in one fluid route, and water vapor and such like is flushed in the other fluid route, the moisture transfers to one fluid route side based on the membrane separation effects, and the gas body subject to humidification can be humidified.

Now, as shown in FIG. 1, both sides of opening means 11 and both sides of opening means 12 are equipped with sealing rings 01, 03, 02 and 04. By means of these the leakage of fluid between each fluid route, or to the outside, is prevented.

### Advantageous Points Concerning the Hollow Fiber Membrane Module of this Embodiment.

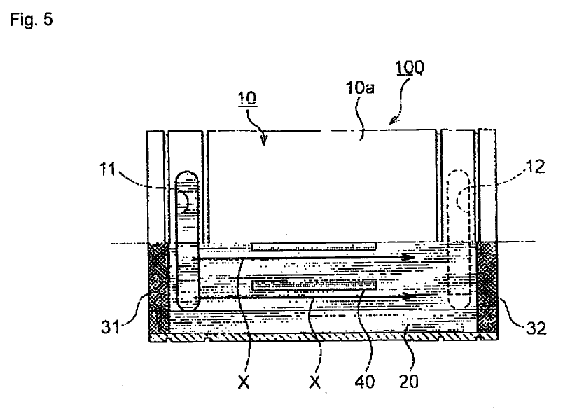

Referring in particular to FIGS. 5 to 7, the advantageous points of the hollow fiber membrane module of the present embodiment are explained. All of FIGS. 5 to 7 explain the manner of flow of fluid flowing along the outside wall of the hollow fiber membranes. Now each of FIGS. 5, 6 and 7 correspond to FIGS. 2, 3 and 4, respectively. The arrow X in these drawings show the manner of flow of the fluid flowing along the outside wall of the hollow fiber membranes.

By means of the hollow fiber membrane module 100 in the present embodiment, because the fluid which entering at one surface 10a, of the opposing pair of surfaces, flows to the other surface 10b, the variation between the fluid flow in the vicinity of the center of the hollow fiber membrane stack and the fluid flow in the vicinity of the periphery can be controlled.

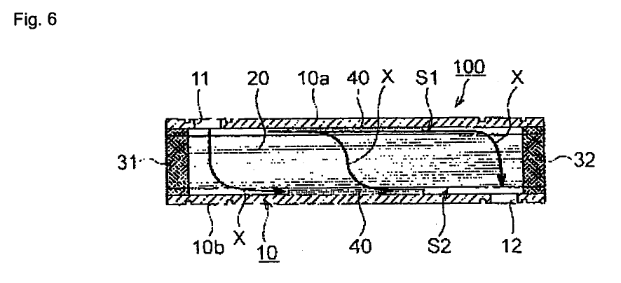

Also, by means of the gap S1 provided between the one surface 10a and the hollow fiber membrane stack 20, the fluid which enters from the opening means 11 which is the entrance, can flow through the whole space from one extreme side of the case 10 to the other extreme side without meeting much resistance. Moreover, by means of the gap S2 provided between the other surface 10b and the hollow fiber membrane stack 20, the fluid heading for the opening means 12 which is the entrance, can also flow through the whole space from one extreme side of the case 10 to the other extreme side without meeting much resistance (Refer to FIG. 5 and FIG. 6). Now the gaps S1 and S2 are each preferably set at a width which is 20% of the hollow fiber membrane stack 20 width (Distance from the entrance side surface to the exit side surface).

By means of this, mitigation of the flow concentration in the vicinity of the opening means 11 and in the vicinity of the opening means 12 is enabled. For this reason, in respect of the whole domain direction from one extreme side of case 10 to the other extreme side, the proportion of fluid flow volume perpendicular to the long direction of the hollow fiber membrane can be increased.

From the above, the proportion of utilized membrane area can be increased in respect of the membrane surface area of the hollow fiber membrane stored in case 10. By means of this, if the hollow fiber membrane module 100 of the present embodiment is utilized as a humidifier, the humidification efficiency can be raised. Moreover, the miniaturization of the hollow fiber membrane module 100 is enabled. In particular, the devices for humidification of the fuel gases in fuel cells (hydrogen, oxygen, air, etc.) need miniaturization, and the hollow fiber membrane module of the present embodiment could be used favorably.

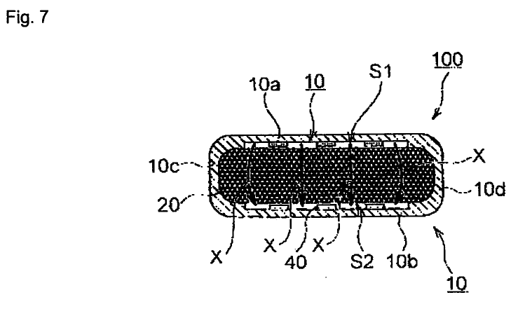

Moreover, because no gap is configured between the pair of side surfaces 10c and 10d and the hollow fiber membrane stack 20, the escape of fluid by the side of hollow fiber membrane stack 20 without going through hollow fiber membrane stack 20 through opening 12 comprising the exit can be controlled (Refer to FIG. 7).

In particular, in the present embodiment, no gap is configured between the surface 10a and the hollow fiber membrane stack 20, or between the other surface 10b and the hollow fiber membrane stack 20 at the extreme sides of the hollow fiber membrane stack 20. Therefore, the escape of fluid by the side of hollow fiber membrane stack 20 without going through hollow fiber membrane stack 20 through opening 12 comprising the exit can be effectively controlled (Refer to FIG. 7).

Moreover, in the present embodiment, by providing the current plates 40, the fluid which enters from opening means 11 which is the entrance as well as the fluid heading for opening means 12 which is the exit, can flow without meeting much resistance through the whole space from one side extreme of case 10 to the other side extreme. Now, the length of the long side of current plates 40 (the long direction of the hollow fiber membrane) should be set at 40-95% of the length of the long direction of opening means 11 and 12.

In addition, the width direction domain W of the opening 11 which is the entrance and the opening 12 which is the exit are formed on substantially the full width extreme parts of the provided gaps S1 and S2. Therefore, variation between the flow rate through the vicinity of the center of the hollow fiber membrane stack 20 and the flow rate in the vicinity of both sides can be controlled.

Now in the hollow fiber membrane module 100, if the effective length of the hollow fiber membrane of the hollow fiber membrane stack 20 (corresponding to the distance between the inner walls sealing and fixing means 31 and 32) is 1, then setting the horizontal width of the hollow fiber membrane stack 20 (the width in the horizontal direction of the hollow fiber membrane stack 20 in FIG. 4) at 0.40 to 0.85, and the thickness of the hollow fiber membrane stack 20 at 0.10 to 0.35 is preferable. By doing so, when fluid flows inside the hollow fiber membrane stack 20, the pressure loss of the fluid can be controlled. Moreover, related to this, the flow of fluid in respect of the hollow fiber membrane stack 20 can be maintained uniform.

In particular, if the thickness of hollow fiber membrane stack 20 (almost equal to the diagonal distance traveled by the fluid through the hollow fiber membrane stack 20) is too thick, pressure losses become great. This can cause the prevention of uniform fluid flow of the fluid through the hollow fiber membrane stack 20. In respect of that, by setting the above mentioned dimensions, pressure losses are effectively controlled.

### EMBODIMENT 2

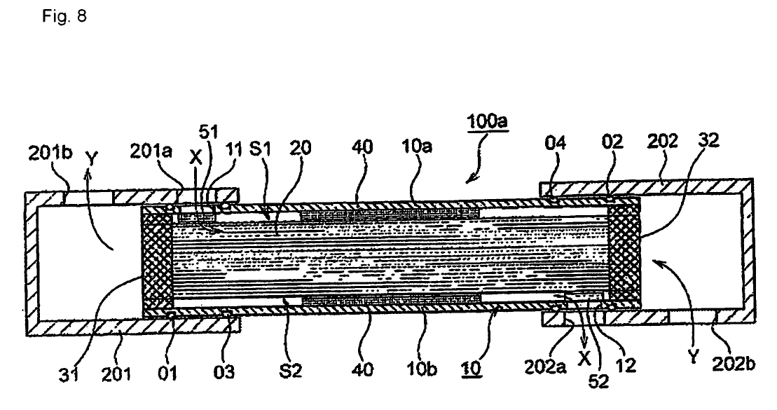

Embodiment 2 of the present invention is shown in FIG. 8 to FIG. 10. In this embodiment, in addition to the configuration of embodiment 1, the configuration of the provision of shock absorbing materials to alleviate the impact of the fluid in the vicinity of the entrance means formed on the case is explained. Because the other configurations and uses are the same as in embodiment 1, the same reference numerals are applied to the same constituent parts and the explanation is abbreviated appropriately.

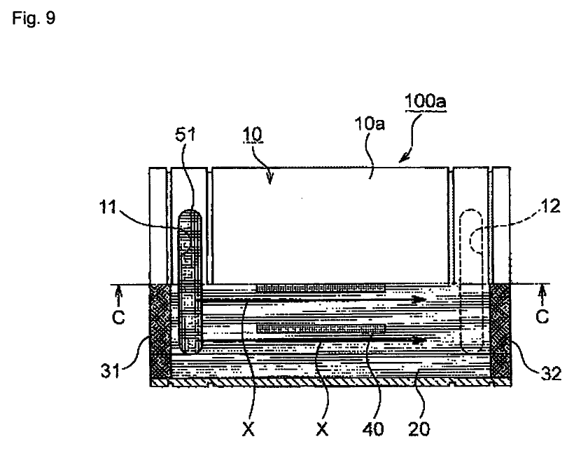

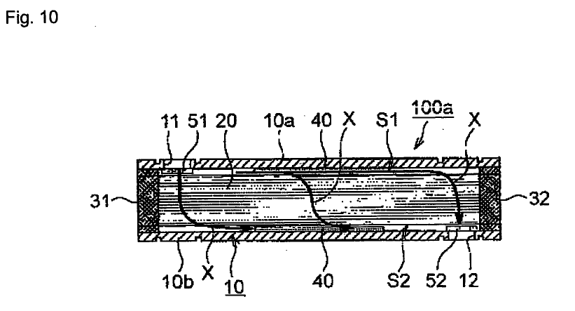

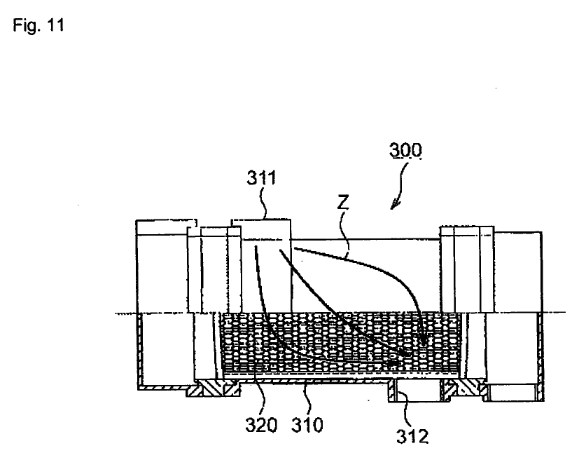

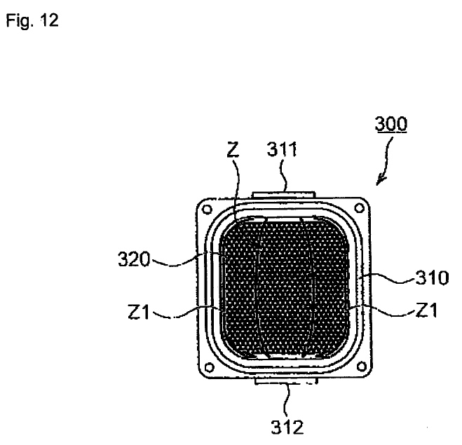

The hollow fiber membrane module of embodiment 2 of the present invention is explained while referring to FIGS. 8 to 10. FIG. 8 is a cross-section diagram showing the use state of the hollow fiber membrane module of embodiment 2 of the present invention. FIG. 9 is a partial cross-section diagram (the upper half is a front elevated view, the lower half is a cross section) of the hollow fiber membrane module of embodiment 2 of the present invention as seen from the front side. FIG. 10 is a cross section diagram of the hollow fiber membrane module of embodiment 2 of the present invention sectioned parallel to the hollow fiber membrane.

The hollow fiber membrane module 100a of the present embodiment has, in respect of the configuration of the hollow fiber membrane module 100 of the embodiment 1 described above, shock absorbing materials 51 provided. These shock absorbing materials 51 should be provided at locations between the fluid flow route from the opening means 11 which is the entrance on the case exterior and the hollow fiber membrane stack 20, on the inner wall of one surface 10a of case 10, provided to cover opening 11.

These buffering materials 51 have plural holes through opening means 11 from the case inside to outside, distributing the flow of fluid, in order to buffer the impact of the fluid flow. As specific examples of the shock absorbing materials 51, mesh shaped materials comprised of metal, polymer, elastomer and such like, or porous material comprised of polymer, elastomer, ceramic and such like may preferably be used. Now the material should be suitably selected so as not to be degraded by the corresponding fluid (gas or liquid) passing through opening means 11.

Here, when mesh shaped materials are used as the shock absorbing materials 51, because of the interplay between the shock absorbing function (distributing the flow of the fluid, with a controlling function on the direct impact of the fluid in respect of the hollow fiber membrane stack 20) and the pressure loss (the less the pressure losses the better), it is desirable that the diameter of the mesh holes be from 0.2 mm to less than or equal to 6.0 mm. Moreover, from the above mentioned interplay, the mesh void ratio should preferably be from 40% to 98%. Now, the bigger the mesh hole diameters are, the less the shock absorbing function, while the smaller the mesh hole diameter, the greater the pressure losses. Moreover, the higher the interval ratios are, the less the shock absorbing function, while the smaller the mesh interval ratios, the greater the pressure losses.

Moreover, if the shock absorbing materials 51 are too thick the pressure losses increase, and because their mechanical strength goes down if they are thinner, it is necessary to set an appropriate thickness. For example, in a mesh made of SUS it should preferably be set from 0.3 mm to 2 mm, in the case of polymer or elastomer mesh it should be 0.1 mm to 1 mm, in the case of a polymer or ceramic porous materials it should preferably be set between 1 mm and 3 mm.

Now in this embodiment, shock absorbing material 52 should also be provided in the same way on the opening means 12 side which is exit. This is to enable the use of either as the entrance.

As described above, by use of the hollow fiber membrane module 100a of the present embodiment, the impact of the fluid entering from the opening 11 which is the entrance to the inside of the case 10, is buffered by shock absorbing materials 51. Moreover, by providing multiple holes in shock absorbing materials 51, the fluid is distributed while being lead into the interior of the hollow fiber membrane stack 20.

Therefore, the impact of the fluid flowing in is buffered and the hollow fiber membrane stack 20 in the vicinity of the entrance is used effectively.

What is claimed is:

1. A hollow fiber membrane module comprising: plural hollow fiber membranes stacked in a hollow fiber membrane stack;
a cylindrical case storing the said hollow fiber membrane stack; and
a sealing fixing device to seal and fix the ends of said hollow fiber membrane stack at one end and at the other end of said case enabling the release of a hollow part of each of the hollow fiber membranes; and
a body of said case, having an entrance opening on one extreme side of the case as an entrance for the fluid route along an outer surface side of the hollow fiber membranes in the case, an other extreme side of the case of the hollow fiber membrane module having an exit opening as an exit for the fluid route, said case providing a pair of surfaces facing each other, and another pair of surfaces joining that pair of surfaces, the entrance opening being formed on one surface of the said opposing pair of surfaces, and the exit opening being formed on the other surface, a gap being formed between one of said opposing pair of surfaces and the hollow fiber membrane stack, and between the other opposing surface and the hollow fiber membrane stack in a region in a direction from one extreme side of the case to the other extreme side of the case with the exception of the part providing the said sealed fixing device, no gap being configured between said pair of opposing surfaces and the hollow fiber membrane stack.

2. The hollow fiber membrane module claimed in claim 1 wherein no gap is configured between one of the said opposing pair of surfaces and the hollow fiber membrane stack, or between the other opposing surface and the hollow fiber membrane stack in the extreme of the width direction of the hollow fiber membrane stack.

3. The hollow fiber membrane module claimed in claim 1 wherein the gaps formed between one of the said opposing pair of surfaces and the hollow fiber membrane stack, and between the other opposing surface and the hollow fiber membrane stack being maintained greater than a certain prescribed width, and further comprising current plates in each gap to regulate the fluid flow from one extreme side of the case in the direction of the other extreme side.

4. The hollow fiber membrane module claimed in claim 1 wherein the entrance opening and the exit opening are formed in the width direction region on substantially opposite full width where the gap is provided.

5. The hollow fiber membrane module claimed in claim 1 wherein plural holes through the case from inside to outside at locations between the case exterior and the hollow fiber membrane stack along the flow route of the fluid flowing from the entrance opening are provided and further comprising shock absorbing materials to buffer the impact of the flow.

6. The hollow fiber membrane module claimed in claim 5 wherein the said shock absorbing materials are mesh shaped and a hole diameter in said mesh shaped materials being 0.2 mm or greater and less than or equal to 6.0 mm.

7. The hollow fiber membrane module claimed in claim 5 wherein by the said shock absorbing materials are mesh shaped and a void ratio of said mesh shaped materials is 40% or greater and less than or equal to 98%.
